(19) United States
(12) Patent Application Publication
(10) Pub. No.: US 2004/0180233 A1
(43) Pub. Date: Sep. 16, 2004

(54) Product having a layer which protects against corrosion. and process for producing a layer which protects against corrosion

(75) Inventor: Werner Stamm, Ruhr (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 10/811,891

(22) Filed: Mar. 30, 2004

Related U.S. Application Data
(63) Continuation-in-part of application No. 10/602,625, filed on Jun. 25, 2003.
Application No. 10/602,625 is a continuation of application No. 09/674,328, filed on Mar. 14, 2001, now Pat. No. 6,610,419.
(63) Continuation-in-part of application No. 10/279,580, filed on Oct. 24, 2002, now abandoned.

(30) Foreign Application Priority Data
Apr. 29, 1998 (DE) 19819026.3
Oct. 24, 2001 (EP) 01125260.8

(51) Int. Cl. B32B 15/00

(52) U.S. Cl. 428/680; 428/678; 428/633; 420/443; 420/445

(57) ABSTRACT

A product (1), in particular a gas-turbine blade (1), has a metallic basic body (2) to which a protective layer (3, 4) for protecting against corrosion is bonded. The protective layer (3, 4) has an inner layer (3) of a first MCrAlY alloy and an outer layer (4) having a second MCrAlY alloy, which is bonded to the inner layer (3). The second MCrAlY alloy is predominantly in the γ-phase and includes 24% to 26% by weight of cobalt. According to a process for producing a protective layer (3, 4), the outer layer (4) is produced by re-melting a region of the inner layer (3) or by deposition of an MCrAlY alloy from a liquid phase.

### CROSS REFERENCE TO RELATED APPLICATIONS

This application is a Continuation-in-Part (CIP) of application Ser. No. 10/602,625, filed Jun. 25, 2003, which is a continuation of U.S. Ser. No. 09/674,328, filed Apr. 22, 1999, now U.S. Application No. 6,610,419, issued Aug. 26, 2003, the contents of which are hereby incorporated by reference. This application is also a Continuation-in-Part (CIP) of U.S. application Ser. No. 10/279,580, filed Oct. 24, 2002, the contents of which are hereby incorporated by reference.

### BACKGROUND OF THE INVENTION

The invention relates to a product having a metallic basic body and a protective layer positioned thereon for protecting the basic body against corrosion, in particular when the product is exposed to a hot, aggressive gas. The protective layer contains an alloy of type MCrAlY, where M represents one or more elements selected from the group consisting of iron, cobalt or nickel, Cr represents chromium, Al represents aluminum and Y represents yttrium and/or an element selected from the group consisting of scandium and the rare earths. An aspect of the invention also relates to a gas-turbine blade having a protective layer and to a process for producing a protective layer for protecting a product against corrosion.

Protective layers for metallic components that are intended to increase the resistance to corrosion and/or oxidation of the components are known from the related art. Most of the protective layers are known under the collective name MCrAlY, where M represents at least one of the elements from the group containing iron, cobalt and nickel, and further essential constituents are chromium, aluminum and yttrium. The latter may also be completely or partially replaced by an equivalent element from scandium or the rare earths.

Typical coatings of this type are known from U.S. Pat. Nos. 4,005,989 and 4,034,142. Moreover, it is known from the latter patent that an additional silicon fraction can further improve the properties of protective layers of the type mentioned above.

Furthermore, Published, European Patent Application EP 0 194 392 A discloses numerous specific compositions for protective layers of the above type with the addition of further elements for various applications. The element rhenium added in amounts of up to 10% by weight is mentioned as well as many other elements that can be added if desired. However, on account of relatively unspecific, wide ranges for possible additions, none of the protective layers described is qualified for particular conditions, such as for example those that occur at rotor blades and guide vanes of gas turbines with high entry temperatures which have to be operated for prolonged periods.

Protective layers which contain rhenium are also known from U.S. Pat. No. 5,154,885, Published, European Patent Application EP 0 412 397 A (corresponding to U.S. Pat. Nos. 5,273,712, 5,154,885, and 5,268,238), German Patent DE 694 01 260 T2 (corresponding to U.S. Pat. No. 5,455,119) and International Patent Disclosure WO 91/02108 A1 (corresponding to U.S. Pat. No. 5,401,130). The disclosures that can be found in these documents as a whole are incorporated in its entirety in the present application.

Ways of applying a protective layer to a component which is to be subject to high thermal loads in a gas turbine are to be found in Published, European Patent Application EP 0 253 754 A1 (corresponding to U.S. Pat. No. 4,743,462).

Efforts to increase the entry temperatures both in stationary gas turbines and in aircraft engines are of considerable importance in the specialist field of gas turbines, since the entry temperatures are important variables in determining the thermodynamic efficiencies which can be achieved by gas turbines. The use of specially developed alloys as base materials for components which are to be subject to high thermal loads, such as guide vanes and rotor blades, and in particular the use of single-crystal superalloys, makes it possible to have entry temperatures of well above 1000.degree. C. By now, the related art allows entry temperatures of 950.degree. C. and above in stationary gas turbines and 1100.degree. C. and above in gas turbines of aircraft engines.

Examples of the construction of a turbine blade or vane with a single-crystal substrate, which for its part may be of complex structure, are to be found in International Patent Disclosure WO 91/01433 A1 (corresponding to U.S. Pat. No. 5,106,266).

While the physical load-bearing capacity of the by now highly developed base materials for the highly loaded components are substantially problem-free with regard to possible further increases in the entry temperatures, to achieve a sufficient resistance to oxidation and corrosion it is necessary to have recourse to protective layers. In addition to the sufficient chemical resistance of a protective layer to the attacks which are to be expected from flue gases at temperatures of the order of magnitude of 1000.degree. C., a protective layer must also have sufficiently good mechanical properties, not least with regard to the mechanical interaction between the protective layer and the base material. In particular, the protective layer must be sufficiently ductile to be able to follow any deformation of the base material without cracking, since this would create points of attack for oxidation and corrosion. In this context, the problem typically arises that an increase in the levels of elements such as aluminum and chromium, which are to be able to improve the resistance of a protective layer to oxidation and corrosion, leads to a deterioration in the ductility of the protective layer, so that there will be an expectation of mechanical failure, in particular of the formation of cracks, in the event of a mechanical load which customarily occurs in a gas turbine. Examples of the way in which the ductility of the protective layer is reduced by the elements chromium and aluminum are known from the related art.

International Patent Disclosure WO 01/09403 A1 discloses a superalloy for a substrate, which likewise contains rhenium. The document describes that the intermetallic phases formed by rhenium reduce the long-term stability of the superalloy. The problem can be alleviated by the addition of ruthenium.

EP 0 486 489 B1 has described a corrosion-resistant protective coating for medium and high temperatures of up to 1050° C. for a gas-turbine part made from a nickel-base or cobalt-base alloy. The protective coating contains, in % by weight, 25 to 40% nickel, 28-30% chromium, 7-9% aluminum, 1-2% silicon and 0.3 to 1% of at least one reactive element selected from the rare earths, at least 5% cobalt and, optionally, 0 to 15% of at least one of the elements selected from the group consisting of rhenium, platinum, palladium, zirconium, manganese, tungsten, titanium, molybdenum, niobium, iron, hafnium and tantalum. In the specific embodiments described, the protective coating contains only the elements nickel, chromium, aluminum, silicon, yttrium and, in addition, rhenium in a range from 1 to 15%, remainder cobalt. The addition of the rhenium significantly improves the corrosion properties.

US-A4,321,310 and U.S. Pat. No. 4,321,311, as well as EP 0 042 872 B1, which corresponds to the latter, each describe a gas-turbine component which has a basic body made of a nickel-base superalloy (MAR-M 200). A layer of an MCrAlY alloy, in particular an NiCoCrAlY alloy with 18% chromium, 23% cobalt, 12.5% aluminum, 0.3% yttrium, remainder nickel, is applied to the base material. This layer of the MCrAlY alloy, according to US-A4,321,310 has a polished surface to which an aluminum oxide layer is applied. The other two patents listed also have an aluminum oxide layer. A ceramic thermal barrier coating which has a columnar structure is applied to this aluminum oxide layer.

U.S. Pat. No. 4,585,481 has likewise disclosed protective layers for protecting a metallic substrate made from a superalloy against high-temperature oxidation and corrosion. MCrAlY alloys are used for the protective layers. This document specifies 5 to 40% chromium, 8-35% aluminum, 0.1 to 2% of an oxygen-active element from group IIIB of the Period System, including the lanthamides and actinides and mixtures thereof, 0.1 to 7% silicon, 0.1 to 3% hafnium, remainder comprising nickel and/or cobalt. The corresponding protective layers of MCrAlY alloy are, according to U.S. Pat. No. 4,585,481 applied by a plasma spraying process.

German laid-open specification DE 196 09 698 A1 has disclosed a turbine blade with a corrosion resistant MCrAlY protective layer, in which the surface layer of the MCrAlY protective layer, over a large area and down to a depth of 5 to 50 μm, is present uniformly over the entire surface layer of a single-phase alloy, the single-phase alloy being produced by re-melting using a pulsed electron beam. Brief diffusion and rapid cooling of the protective layer, so that there is no time for phase segregation, results in the single-phase structure which leads to the formation of uniform, uninterrupted oxide coating layers of Al2O3. Compared to coating layers of aluminum oxide with an interrupted structure, there is a reduced tendency to spall (flake). In coating layers with an interrupted structure with some flaking, such damage to the oxide coating layer can be healed by migration of aluminum from the protective layer. However, this may lead to the levels of aluminum in the MCrAlY protective layer becoming depleted. Re-melting with a pulsed electron beam eliminates production-related micro-roughness of the surface through the process of surface treatment and therefore reduces heat transfer between a hot gas and the surface of the protective layer, which would allow a higher gas temperature for a gas turbine.

WO 81/01983 A1 has disclosed a process for the production of a metallic component which includes a ceramic thermal barrier coating. In this process, a thin layer of MCrAlY alloy is applied to the substrate made from a superalloy with a clean surface, this layer is polished, and then an aluminum oxide layer is applied and a columnar ceramic layer is produced on the aluminum oxide layer by vapor deposition.

EP 0 846 788 A1 relates to a product, in particular a gas turbine component, having a substrate on which a protective layer of an alloy of type MCrAlY is arranged and on this protective layer there is a ceramic thermal barrier coating. The substrate is a nickel-based superalloy which contains chromium. An outer layer of the substrate is chromium-enriched, this chromium having diffused into the substrate by a diffusion process. The chromium has diffused into the substrate and forms a matrix which contains chromium in the gamma phase dissolved in the nickel. The diffusion of the chromium is carried out using the so-called “chromizing” process.

EP 0 718 420 A1 has described a process for applying a thermal barrier coating to a component made from a superalloy. The thermal barrier coating is in this case composed of various layers. A layer of a metal from the platinum group directly adjoins the product made from the superalloy. This layer of the metal from the platinum group comprises an outer layer and an inner layer, the outer layer containing the metal of the platinum group in the γ-phase. An aluminum-containing coating is arranged on the outer part of the layer of the metal from the platinum group. A thin oxide layer is applied to this aluminum-containing coating, and a ceramic coating is in turn applied to the thin oxide layer.

U.S. Pat. No. 4,321,310 and US-A4,321,311 have each disclosed coating systems for a component of a turbine in which a protective layer of an MCrAlY alloy is applied to the component, this protective layer being adjoined by an aluminum oxide layer as adhesion-promoter layer or bonding layer, to which a ceramic thermal barrier coating is applied. Both documents deal with the problem on which this coating system is based of bonding the thermal barrier coating to the MCrAlY protective layer via the aluminum oxide bonding layer. To improve the bonding, according to U.S. Pat. No. 4,321,310 the surface of the aluminum oxide bonding layer is to be polished. According to U.S. Pat. No. 4,321,311, a novel microstructure of the ceramic thermal barrier coating is proposed in order to improve the bonding.

### SUMMARY OF THE INVENTION

An aspect of the invention is to provide a product having a metallic basic body and a coating system which is applied thereto and comprises a protective layer, a bonding layer and a thermal barrier coating, and a process for producing a coating system of this type, in which good bonding of the thermal barrier coating is ensured.

A product having a metallic basic body is achieved by the fact that a protective layer of an MCrAlY alloy is applied to the basic body, a thin bonding layer containing aluminum oxide is applied to the protective layer and a thermal barrier coating is applied to this thin boding layer. The protective layer may have an inner layer of a first MCrAlY alloy and an outer layer of a second MCrAlY alloy which is predominantly in the γ-phase, and the aluminum oxide being predominantly in the α-phase. The term alloy of type MCrAlY is understood as meaning an alloy which comprises an amount of chromium, of aluminum and a reactive element such as yttrium and/or at least one equivalent metal selected from the group consisting of scandium and the rare earths.

In addition or as an alternative to yttrium, there may be further elements in the alloy, such as for example rhenium, silicon, hafnium, tantalum, zirconium, tungsten, magnesium or niobium. In particular, a rhenium content may lead to an improvement in the corrosion properties. As the remainder the MCrAlY alloy contains one or more elements selected from the group consisting of iron, cobalt and nickel, this being symbolically abbreviated by M.

An MCrAlY alloy of this type is preferably used as an anti-corrosion layer on metallic components, in particular having a basic body made from a superalloy (nickel or cobalt superalloy, if appropriate also iron superalloy) which is exposed to an elevated temperature and a hot, aggressive gas. The decisive advantage of the MCrAlY alloy described here is that it is eminently suitable as an adhesion layer for secure and permanent bonding of the thermal barrier coating. The result is a coating system which inhibits both corrosion and oxidation and allows the product to be used at a high temperature of, for example, over 1000° C.

On account of the outer layer, which contains an MCrAlY alloy which is predominantly in the γ-phase, in the event of oxidation of the outer layer an aluminum oxide grows on (thermally grown oxide), and this oxide is in the α-modification in the regions of the γ-phase of the MCrAlY alloy. Therefore, the aluminum oxide is predominantly in the stable α-modification as early as the initial stage of growth of the aluminum oxide layer. This has the advantage that, compared to aluminum oxide which initially grows on in the θ-phase, the aluminum oxide layer grows on with a greater density, a lower oxidation rate and a smoother structure, so that longer adhesion of the aluminum oxide layer to the outer layer is ensured. In this matter, the inventor recognized that, partially or completely, a θ-phase of the aluminum oxide is formed on an MCrAlY layer surface in the initial stage of oxidation wherever the MCrAlY alloy is in the β-phase. The aluminum oxide which grows on in the θ-phase has a low density, a high oxidation rate and a pointed structure, so that, although subsequently, beyond a certain layer of thickness, the stable α-modification is established, failure, i.e. flaking, of the aluminum oxide layer may occur. Therefore, it is particularly advantageous if the MCrAlY alloy in the outer layer is almost entirely in single phase form in the γ-phase. This also results in good bonding of thermal barrier coatings, in particular ceramic layers which are applied by an electron beam PVD process, to an adhesion-promoter layer comprising an MCrAlY alloy. Due to the thin aluminum oxide layer in the stable α-modification which forms, the bonding to the MCrAlY alloy, which is substantially in the γ-phase, is significantly better than the bonding to an MCrAlY alloy which has regions containing the β-phase and has been mechanically smoothed. This is because the mechanically smoothed MCrAlY alloy which is predominantly in the β-phase leads to a significantly thicker aluminum oxide layer in the θ-phase growing on, the greater thickness and the layer growth of this aluminum oxide layer leading to flaking of the aluminum oxide layer after even a relatively short time.

The second MCrAlY alloy preferably has the same chemical composition as the first MCrAlY alloy, although, depending on the properties of the individual alloying constituents, there may also be differences of a few percent by weight or a few tenths of a percent by weight between the respective, corresponding alloying constituents of the first MCrAlY alloy and the second MCrAlY alloy. It is also possible for the second MCrAlY alloy to contain additional or alternative alloying elements to the first MCrAlY alloy.

The outer layer is preferably on average between 5 μm and 50 μm thick, in particular less than 20 μm thick. The total mean layer thickness of the protective layer is preferably between 100 μm and 200 μm.

Preferably, the first MCrAlY alloy and/or the second MCrAlY alloy contain(s) the following alloying constituents (data in percent by weight): 15 to 35% chromium; 7 to 18% aluminum; 0.3 to 2% yttrium and/or at least one equivalent element selected from the group consisting of scandium and the rare earths; 24% to 26% by weight, more particularly 24.5% to 25.5% by weight, and still more particularly 24.9% to 25.1% by weight cobalt; and, optionally, 0 to 20% rhenium and further optional alloying elements, such as hafnium, silicon, tantalum, zirconium, tungsten, magnesium and niobium. The rhenium content is preferably between 1% and 20%, in particular between 5% and 11%. M represents the cobalt and at least one of Fe and Ni.

A thin bonding layer substantially comprising aluminum oxide (Al2O3) which is in the α-phase is preferably bonded to the outer layer. At the beginning of an oxidation process, the thickness of the bonding layer is preferably between 0.3 μm and 0.6 μm. Due to the high level of aluminum oxide in the α-phase, preferably virtually exclusively aluminum oxide in the α-phase, in the event of oxidation of the MCrAlY alloy in the outer layer, the bonding layer grows with a significantly lower growth rate than if there is a high level of aluminum oxide in the θ-phase. In this case, a bonding layer which contains almost exclusively aluminum oxide in the α-phase from the beginning of an oxidation process is particularly advantageous, since this ensures uniform, homogenous, low growth of the bonding layer.

The thermal barrier coating which has been applied to the bonding layer preferably contains a columnar microstructure, the axial direction of the crystallites which are present in the columnar microstructure being substantially perpendicular to the surface of the basic body. The thermal barrier coating is preferably between 150 and 3500 μm, preferably approximately 200 μm, thick. The columnar, stalk-like crystallites preferably have a mean diameter of less than 5 μm, in particular less than 2.5 μm. In this case the thermal barrier coating preferably contains a ceramic which is in particular zirconium oxide partially stabilized with yttrium oxide. Depending on the demands imposed on the product, it is also possible to use other thermal barrier layers comprising tertiary oxides, spinels or mullites.

The product is preferably a component of a gas turbine, in particular a gas-turbine blade, a rotor blade or a guide vane. Gas-turbine blades in the first two rows of guide vanes and the first rows of rotor blades immediately downstream of a combustion chamber of a gas turbine are preferably coated with a protective layer of the abovementioned type and a thermal barrier coating which is bonded on via a bonding layer of aluminum oxide.

The outer layer of the protective layer is preferably produced by re-melting the inner layer in the region of its surface, i.e., a region of the inner layer is re-melted. This re-melting is preferably carried out by electron beams or ion beams which bring about rapid re-melting without a significant change in the chemical composition of the MCrAlY alloy in the outer layer and the inner layer. As a result of melting of the free, i.e. untreated, surface of the MCrAlY alloy of the inner layer by electron beams, ion beams or the like, it is possible to produce a substantially pure, temperature-stable γ-phase which forms the outer layer in the upper peripheral regions of a few micrometers. This γ-phase, as stated above, leads to a stable, dense and thin α-aluminum oxide layer, the bonding layer, being formed immediately during the formation of an oxide layer on the surface of the outer layer. The oxide formed by oxidation, which is predominantly aluminum oxide, is referred to as thermally grown oxide (TGO). The formation of this oxide, the bonding layer, may occur both before application of the thermal barrier coating and during and after the application of the thermal barrier coating. The thermal barrier coating is, in this case, preferably applied by vapor deposition. On account of the low growth rate and homogenous structure of the thermally grown oxide (TGO), the stresses in the region of the thermally grown oxide, the bonding layer, when the product is used at a high temperature in an oxidizing and corrosive environment, in particular when a hot, aggressive gas is flowing around it, are reduced. As a result, the service life of thermal barrier layers which are bonded on to the basic body via the bonding layer and the protective layer is increased, since flaking of the bonding layer takes place at a later time due to the reduced growth of the thermally grown oxide.

It is also possible for the outer layer to be applied from a liquid phase, in particular by electrodeposition, to an inner layer of an MCrAlY alloy which has already been applied. In this case, the inner layer may be applied to the basic body in a suitable way, if appropriate likewise by deposition from a liquid phase. In this case, the second MCrAlY alloy of the outer layer has the composition of a γ-phase. The first MCrAlY alloy may be sprayed on by known techniques.

The aspect relating to a process for producing a protective layer on a metallic basic body of a product is achieved by the fact that an inner layer having a first MCrAlY alloy is applied, and this inner layer is re-melted in the region of its free surface in such a way that an outer layer is formed, in which the MCrAlY alloy is substantially in the γ-phase. Alternatively, it is possible for a second MCrAlY alloy to be deposited from a liquid phase, in particular by electrodeposition, onto the first MCrAlY alloy, which forms the inner layer and has been sprayed on by known techniques or has been electrodeposited, the second MCrAlY alloy forming the outer layer and being substantially in the γ-phase.

The invention, the aspect relating to a gas-turbine blade having a metallic basic body, is achieved by the fact that a protective layer (adhesion layer) for protecting against corrosion is bonded to the metallic basic body. This protective layer may contain an inner layer of a first adhesion alloy which is bonded to the basic body, and an outer layer having a second adhesion alloy, which is bonded to the inner layer, the second adhesion layer being predominantly, preferably almost completely, in the γ-phase, and a thin bonding layer containing aluminum oxide predominantly in the α-phase being bonded to the outer layer, with a thermal barrier coating bonded to this thin bonding layer. The first adhesion alloy and the second adhesion alloy are preferably each an (identical) alloy of type MCrAlY, modified according to requirements by the addition of one or more alloying elements, in particular rhenium.

The basic body, preferably consists of a nickel-base or cobalt-base superalloy, if appropriate also an iron-based superalloy.

### BRIEF DESCRIPTION OF THE DRAWINGS

These and/or other aspects and advantages of the present invention will become more apparent and more readily appreciated from the following description of the preferred embodiments, taken in conjunction with the accompanying drawings of which:

FIG. 1 shows a perspective view of a gas-turbine rotor blade, and

FIG. 2 shows part of a section perpendicular to the surface of the gas-turbine rotor blade.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

One aspect of the invention is to provide a rhenium-containing protective layer for protecting a component against corrosion and oxidation at high temperatures which overcome the above-mentioned disadvantages of the related art devices of this general type, which has a good high-temperature resistance to corrosion and oxidation, a good long-term stability and, moreover, is particularly suitable for a mechanical load which is to be expected in particular in a gas turbine at a high temperature.

The related art protective layer has brittle chromium-rhenium precipitations in the layer and in the transition region between the protective layer and the base material. The brittle phases, increasing amounts of which are formed with time and temperature in use, lead to pronounced longitudinal cracks in the layer and in the layer-base material interface during operation, ultimately leading to the layer becoming detached. The interaction with carbon, which can diffuse out of the base material into the layer or diffuses into the layer through the surface during a heat treatment in the furnace, additionally increases the brittleness of the Cr-Re precipitations. The likelihood of cracks being formed is increased still further by oxidation of the chromium-rhenium phases.

To achieve the aspect, a protective layer protects a component against corrosion and oxidation at a high temperature and is substantially composed of the following elements (contents given in percent by weight):

0.5 to 2% of rhenium;

15 to 21% of chromium;

9 to 11.5% of aluminum;

0.05 to 0.7% of yttrium and/or at least one equivalent metal from the group consisting of scandium and the rare earths;

a remainder being cobalt and/or nickel; and

production-related impurities.

The advantageous effect of the element rhenium is exploited to prevent the formation of brittle phases.

It should be noted that the levels of the individual elements are particularly well matched with regard to their affects that originate from the element rhenium. If the levels of the elements are such that no chromium-rhenium precipitations are formed, there are advantageously no brittle phases formed during use of the protective layer, so that the service life is improved and lengthened. This is achieved not only by lowering the chromium content but also by taking account of the influence of aluminum on the phase formation by the reduction in the aluminum content.

The protective layer, with a good resistance to corrosion, also has a particularly good resistance to oxidation and is also distinguished by particularly good ductility properties, making it particularly well qualified for use in a gas turbine in the event of a further increase in the entry temperature. During operation, there is scarcely any embrittlement, since the layer has scarcely any chromium-rhenium precipitations that become brittle during use. The superalloy has no chromium-rhenium precipitations, or at most 6% by volume of chromium-rhenium precipitations.

It is advantageous for the rhenium content to be set at approximately 1.5% wt, the chromium content to be set at approximately 17% wt, the aluminum content to be set at approximately 10% wt, and the yttrium content to be set at approximately 0.3% wt. Certain fluctuations will occur as a result of large-scale industrial production.

One aspect of the invention relates to a component, in particular a component of a gas turbine, which is to be protected against corrosion and oxidation at high temperatures by a protective layer of the type described above.

The protective layer described also acts as a bonding layer to a superalloy. Further layers, in particular ceramic thermal barrier coatings, can be applied to the layer.

In the component, the protective layer is advantageously applied to a substrate containing a nickel-base or cobalt-base superalloy. In particular the following composition is suitable for the substrate (information in percent by weight):

0.03 to 0.5% of carbon;

18 to 19% of chromium;

12 to 15% of cobalt;

3 to 6% of molybdenum;

1 to 1.5% of tungsten;

2 to 2.5% of aluminum;

3 to 5% of titanium; and

optionally small amounts of tantalum, niobium, boron and/or zirconium, remainder nickel.

Such materials are known as forging alloys under the names Udimet 520 and Udimet 720.

Alternatively, the following composition may be suitable for the substrate of the component (details in percent by weight):

0.1 to 0.15% of carbon;

18 to 22% of chromium;

18 to 19% of cobalt;

0 to 2% of tungsten;

0 to 4% of molybdenum;

0 to 1.5% of tantalum;

0 to 1% of niobium;

1 to 3% of aluminum;

2 to 4% of titanium;

0 to 0.75% of hafnium; and

optionally small amounts of boron and/or zirconium, remainder nickel.

Compositions of this type are known as casting alloys under the names GTD222, 1N939, IN6203 and Udimet 500.

A further alternative for the substrate of the component is the following composition (details in percent by weight):

0.07 to 0.1% of carbon;

12 to 16% of chromium;

8 to 10% of cobalt;

1.5 to 2% of molybdenum;

2.5 to 4% of tungsten;

1.5 to 5% of tantalum;

0 to 1% of niobium;

3 to 4% of aluminum;

3.5 to 5% of titanium;

0 to 0.1% of zirconium;

0 to 1% of hafnium; and

optionally a small amount of boron, remainder nickel.

Compositions of this type are known as casting alloys PWA1483SX, IN738LC, GTD111, IN792CC and IN792DS; the material IN738LC is to be considered particularly preferred.

The following composition is considered a further alternative for the substrate of the component (details in percent by weight):

approximately 0.25% of carbon;

24 to 30% of chromium;

10 to 11% of nickel;

7 to 8% of tungsten;

0 to 4% of tantalum;

0 to 0.3% of aluminum;

0 to 0.3% of titanium;

0 to 0.6% of zirconium; and

optionally a small amount of boron, remainder cobalt.

Such compositions are known as casting alloys under the names FSX414, X45, ECY768 and MAR-M-509.

The thickness of the protective layer on the component is preferably between approximately 100 μm and 300 μm.

The protective layer is particularly suitable for protecting a component against corrosion and oxidation while the component is being acted on with a flue gas at a material temperature of around 950° C., and in aircraft turbines even of around 1100° C.

The protective layer is therefore particularly qualified for protecting a component of a gas turbine, in particular a guide vane, rotor blade or other component that is acted on by hot gas upstream of or in the turbine of the gas turbine.

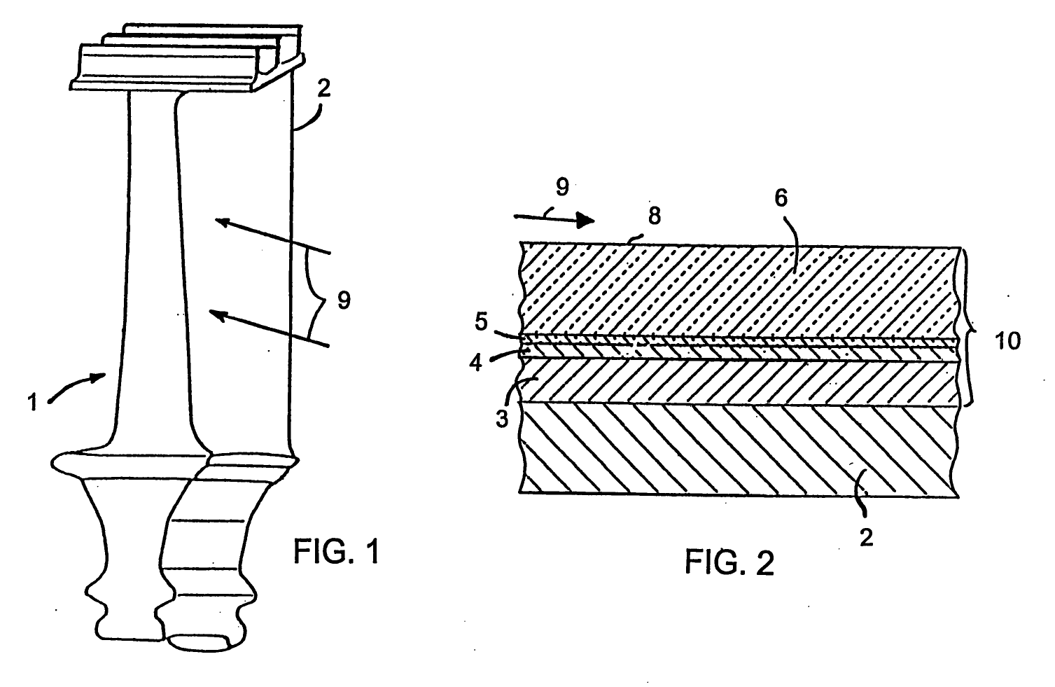

The product 1 illustrated in FIG. 1, which is a gas-turbine rotor blade 1, has a metallic basic body 2 made from a nickel-base or cobalt-base superalloy. As shown in FIG. 2, a protective layer 3, 4, which serves as an adhesion layer and comprises an inner layer 3 which is directly bonded to the basic body 2 and an outer layer 4 which is bonded to inner layer 3, is applied to the basic body 2. The inner layer 3 contains a first alloy of type MCrAlY, and the outer layer has a second alloy, likewise of type MCrAlY, the second alloy being substantially preferably almost entirely in the γ-phase. A thermal barrier coating 6, which preferably comprises a columnar ceramic, for example zirconium oxide which is partially stabilized with yttrium oxide, is bonded to this protective layer 3, 4, which serves as an adhesion layer. A bonding layer 5 is arranged between the protective layer 3, 4 and the thermal barrier coating 6. This bonding layer 5 preferably has a thermally grown oxide, in particular aluminum oxide. Even at the beginning of oxidation, this thermally grown oxide is in the stable α-phase, the immediate formation of the α-phase being brought about at the beginning of oxidation by the γ-phase in the outer layer 4. Compared to a thermally grown oxide which grows on predominantly in the β-phase, the oxide which grows on in the stable α-phase has a significantly lower layer thickness. The result is not only good bonding of the thermal barrier coating to the protective layer 3, 4 but also a significant extension of the service life of the thermal barrier coating 6 on account of the fact that detachment of the bonding layer 5 caused by high layer growth, as would be found with an oxide in the β-phase, is prevented.

When the gas-turbine rotor blade 1 is being used in a gas turbine (not shown), a hot, aggressive gas 9 flows past the outer surface 8 of the thermal barrier coating 6, and this gas is effectively kept away from the metallic basic body 2, both in physical and chemical terms, by the layer system formed from the protective layer 3, 4, the bonding layer 5 and the thermal barrier layer 6. This is particularly advantageous in a gas-turbine rotor blade 1 and in a gas-turbine guide vane which is exposed to the hot gas flowing directly out of a combustion chamber (not shown) at a temperature of up to over 1300° C.

In a gas-turbine rotor blade 1, having a metallic basic body 2 made from a cobalt-based superalloy, selection of a range of approximately 24% to 26% cobalt surprisingly improves markedly and over-proportionally, the thermal and mechanical properties of the protective layer 3 which also serves as an adhesion layer and comprises an inner layer 3 which is directly bonded to the basic body 2 and an outer layer 4, a substrate which is bonded to inner layer 3. With this closely selected range of cobalt, the origination and further formation of the gamma phase of the alloy, which normally leads to a peak in the thermal expansion coefficients, is particularly well suppressed.

Such a peak would otherwise cause high mechanical stresses (thermal mismatch) between layer 3 and the substrate 4 upon strongly heating the component with layer 3 (starting of the turbine) or other temperature fluctuations. This is at least drastically reduced by the cobalt content of approximately 24% to 26% selected according to one embodiment. A more particular cobalt range of 24.5% to 25.5% and still more particular range of 24.9% to 25.1% function well.

In reciprocal action with the reduction of the brittle phases, which have a negative effect, particularly under high mechanical properties, the mechanical properties are improved by the reduction of the mechanical stresses by the selected cobalt content.

The desired formation of the beta phase of the alloy is also particularly promoted by the selection of an approximately 24% to 26% cobalt content.

The invention has been described in detail with particular reference to preferred embodiments thereof and examples, but it will be understood that variations and modifications can be effected within the spirit and scope of the invention.

What is claimed is:

1. A protective layer for protecting a part against corrosion and oxidation at high temperatures, comprising a MCrAlY alloy having alloying constituents essentially consisting of:
15% to 35% chromium by weight;
7% to 18% aluminum by weight;
0% to 20% rhenium by weight; and
24% to 26% cobalt by weight, wherein M represents the cobalt and at least one of Fe and Ni, and Y represents at least one of yttrium and at least one equivalent element selected from the group consisting of scandium and rare earths.

2. The protective layer of claim 1, wherein:
the chromium content is 15% to 21% by weight,
the aluminum content is 9% to 11.5% by weight,
the rhenium content is 0.5% to 2% by weight, and
a content of the at least one of yttrium and at least one equivalent element selected from the group consisting of scandium and rare earths is 0.05% to 0.7% by weight.

3. The protective layer of claim 2, wherein:
the chromium content is 17% by weight,
the aluminum content is 10% by weight,
the rhenium content is 1.5% by weight, and
the content of the at least one of yttrium and at least one equivalent element selected from the group consisting of scandium and rare earths is 0.3% by weight.

4. The protective layer of claim 1, wherein the MCrAlY alloy protective layer comprises:
an inner MCrAlY alloy layer which faces the part; and
an outer MCrAlY alloy layer which is predominantly in a γ-phase.

5. The protective layer of claim 1, wherein the part is a component for a gas turbine.

6. A protective layer for protecting a part against corrosion and oxidation at high temperatures, comprising a MCrAlY alloy having a predominantly γ-phase in an outer portion thereof, wherein M represents approximately 24% to 26% cobalt by weight and at least one of Fe and Ni, and Y represents at least one of yttrium and at least one equivalent element selected from the group consisting of scandium and rare earths.

7. The protective layer of claim 6, wherein the MCrAlY alloy protective layer comprises:
an inner MCrAlY alloy layer which faces the part; and
an outer MCrAlY alloy layer, the outer MCrAlY alloy layer being the outer portion of the protective layer having the predominantly γ-phase.

8. The protective layer of claim 7, wherein:
the outer MCrAlY alloy layer is a free surface portion of the inner MCrAlY alloy layer, and the free surface portion is a layer re-melted by at least one of electron beams and ion beams.

9. The protective layer of claim 7, wherein the outer MCrAlY alloy layer is an electrodeposited MCrAlY alloy predominately in the γ-phase.

10. The protective layer of claim 6, wherein the MCrAlY alloy includes zirconium.

11. The protective layer of claim 6, wherein the MCrAlY alloy includes alloying constituents essentially consisting of:
15% to 35% chromium by weight,
7% to 18% aluminum by weight,
0% to 20% rhenium by weight, and
24% to 26% cobalt by weight.

12. The protective layer of claim 11, wherein:
the chromium content is 15% to 21% by weight,
the aluminum content is 9% to 11.5% by weight,
the rhenium content is 0.5% to 2% by weight, and
a content of the at least one of yttrium and at least one equivalent element selected from the group consisting of scandium and rare earths is 0.05% to 0.7% by weight.

13. The protective layer of claim 12, wherein:
the chromium content is 17% by weight,
the aluminum content is 10% by weight,
the rhenium content is 1.5% by weight, and
the content of the at least one of yttrium and at least one equivalent element selected from the group consisting of scandium and rare earths is 0.3% by weight.

14. The protective layer of claim 6, wherein the part is a component for a gas turbine.

15. The protective layer of claim 6, wherein the outer portion of the protective layer is almost entirely in the γ-phase.

16. A protective layer for protecting a component against corrosion and oxidation at high temperatures, essentially consisting of:
15% to 21% by weight of chromium;
9% to 11.5% by weight of aluminum;
0% to 2% by weight of rhenium;
24% to 26% by weight of cobalt;
0.05% to 0.7% by weight of an element selected from the group consisting of yttrium, scandium and rare earths;
0% to 1% by weight of ruthenium;
a remainder being nickel; and
production-related impurities.

17. The protective layer of claim 16, wherein:
the chromium content is 17% by weight,
the aluminum content is 10% by weight,
the rhenium content is 1.5% by weight, and
a content of the element selected from the group consisting of yttrium, scandium and rare earths is 0.3% by weight, it being possible for the contents listed to fluctuate in a manner customary in industrial production.

18. The protective layer of claim 16, wherein the protective layer contains so few chromium-rhenium precipitations that there is no significant embrittlement of the protective layer.

19. The protective layer of claim 18, wherein a volume of the chromium-rhenium precipitations is at most 6% by volume.

20. A protective layer for protecting a part against corrosion and oxidation at high temperatures, comprising a MCrAlY alloy having alloying constituents essentially consisting of:
15% to 35% chromium by weight;
7% to 18% aluminum by weight; and
0% to 20% rhenium by weight, wherein M represents at least one of Fe, Ni and Co, and Y represents at least one of yttrium and at least one equivalent element selected from the group consisting of scandium and rare earths.

21. The protective layer of claim 20, wherein:
the chromium content is 15% to 21% by weight,
the aluminum content is 9% to 11.5% by weight,
the rhenium content is 0.5% to 2% by weight, and
a content of the at least one of yttrium and at least one equivalent element selected from the group consisting of scandium and rare earths is 0.05% to 0.7% by weight.

22. The protective layer of claim 21, wherein:
the chromium content is 17% by weight,
the aluminum content is 10% by weight,
the rhenium content is 1.5% by weight, and
the content of the at least one of yttrium and at least one equivalent element selected from the group consisting of scandium and rare earths is 0.3% by weight.

23. The protective layer of claim 20, wherein the MCrAlY alloy protective layer comprises:
an inner MCrAlY alloy layer which faces the part; and
an outer MCrAlY alloy layer which is predominantly in a γ-phase.

24. The protective layer of claim 20, wherein the part is a component for a gas turbine.

25. A protective layer for protecting a part against corrosion and oxidation at high temperatures, comprising a MCrAlY alloy having a predominantly γ-phase in an outer portion thereof, wherein M represents at least one of Fe, Ni and Co, and Y represents at least one of yttrium and at least one equivalent element selected from the group consisting of scandium and rare earths.

26. The protective layer of claim 25, wherein the MCrAlY alloy protective layer comprises:
an inner MCrAlY alloy layer which faces the part; and
an outer MCrAlY alloy layer, the outer MCrAlY alloy layer being the outer portion of the protective layer having the predominantly γ-phase.

27. The protective layer of claim 26, wherein:
the outer MCrAlY alloy layer is a free surface portion of the inner MCrAlY alloy layer, and the free surface portion is a layer re-melted by at least one of electron beams and ion beams.

28. The protective layer of claim 26, wherein the outer MCrAlY alloy layer is an electrodeposited MCrAlY alloy predominately in the γ-phase.

29. The protective layer of claim 25, wherein the MCrAlY alloy includes zirconium.

30. The protective layer of claim 25, wherein the MCrAlY alloy includes alloying constituents essentially consisting of:
15% to 35% chromium by weight,
7% to 18% aluminum by weight, and
0% to 20% rhenium by weight.

31. The protective layer of claim 30, wherein:
the chromium content is 15% to 21% by weight,
the aluminum content is 9% to 11.5% by weight,
the rhenium content is 0.5% to 2% by weight, and
a content of the at least one of yttrium and at least one equivalent element selected from the group consisting of scandium and rare earths is 0.05% to 0.7% by weight.

32. The protective layer of claim 31, wherein:
the chromium content is 17% by weight,
the aluminum content is 10% by weight,
the rhenium content is 1.5% by weight, and
the content of the at least one of yttrium and at least one equivalent element selected from the group consisting of scandium and rare earths is 0.3% by weight.

33. The protective layer of claim 25, wherein the part is a component for a gas turbine.

34. The protective layer of claim 25, wherein the outer portion of the protective layer is almost entirely in the γ-phase.

35. A protective layer for protecting a component against corrosion and oxidation at high temperatures, essentially consisting of:
15% to 21% by weight of chromium;
9% to 11.5% by weight of aluminum;
0% to 2% by weight of rhenium;
0.05% to 0.7% by weight of an element selected from the group consisting of yttrium, scandium and rare earths;
0% to 1% by weight of ruthenium;
a remainder selected from the group consisting of cobalt and nickel; and
production-related impurities.

36. The protective layer of claim 35, wherein:
the chromium content is 17% by weight,
the aluminum content is 10% by weight,
the rhenium content is 1.5% by weight, and
a content of the element selected from the group consisting of yttrium, scandium and
rare earths is 0.3% by weight, it being possible for the contents listed to fluctuate in a manner customary in industrial production.

37. The protective layer of claim 35, wherein the protective layer contains so few chromium-rhenium precipitations that there is no significant embrittlement of the protective layer.

38. The protective layer of claim 37, wherein a volume of the chromium-rhenium precipitations is at most 6% by volume.
